(19) United States
(12) Patent Application Publication
(10) Pub. No.: US 2013/0098251 A1
(43) Pub. Date: Apr. 25, 2013

(54) FILTER PANS FOR USE IN FRYER APPARATUS AND FRYER APPARATUS

(71) Applicants: Keith LAMBERT, Lebanon, OH (US); Tom GORT, Carlisle, OH (US); Brian BROOKS, Wilmington, OH (US); Mark KILLION, Richmond, IN (US)

(72) Inventors: Keith LAMBERT, Lebanon, OH (US); Tom GORT, Carlisle, OH (US); Brian BROOKS, Wilmington, OH (US); Mark KILLION, Richmond, IN (US)

(73) Assignee: Henny Penny Corporation, Eaton, OH (US)

(21) Appl. No.: 13/279,032

(22) Filed: Oct. 21, 2011

(51) Int. Cl. A47J 37/12

(52) U.S. Cl. 99/408

(57) ABSTRACT

A fryer apparatus includes a cooking chamber and a filter pan. The filter pan includes an outlet passage, formed through a bottom portion of the filter pan, configured to allow cooking media to be discharged; a groove formed in the bottom portion of the filter pan and surrounding the outlet passage; and a removable, two-sided filter screen having an adaptor configured to couple the filter screen to the bottom portion of the filter pan at the outlet passage. The adaptor includes an engaging portion protruding from the filter screen and configured to fit at least partially into the outlet passage and a raised segment configured to fit at least partially in the groove, such that the filter screen does not contact the bottom portion of the filter pan. Further, the engaging portion includes a connector configured to create a seal between the adaptor and the outlet passage.

### BACKGROUND OF THE INVENTION

1. Field of the Invention

The invention relates generally to a filter pan for cooking media systems that use cooking media to cook product in a fryer apparatus, e.g., a pressure fryer or an open fryer, and such fryer apparatus. Specifically, the invention relates to a filter pan having a removable screen that facilitates filter replacement.

2. Description of Related Art

Known fryer apparatus are used to cook various food products, e.g., poultry, fish, potato products, and the like. Such fryer apparatus may include one or more cooking chambers, e.g., fryer pots, which may be filled with a cooking medium, e.g., an oil, a liquid shortening, or a meltable-solid shortening. Such fryer apparatus also include a heating element, e.g., an electrical heating element, such as a heating oil medium, or a gas heating element, such as a gas burner and gas conveying tubes, which heat the cooking medium in the cooking chamber. When preparing food in a fryer apparatus, the quality of the cooking medium, e.g., the oil or shortening, may impact the quality of the food that is cooked by the fryer apparatus. As the cooking medium is used to cook food, particles of food may contaminate the cooking medium. The flavor characteristics of each of these food products may become infused to a greater or a lesser degree in the cooking medium. This infusion may adversely affect food quality. Moreover, upon heating the cooking medium, the cooking medium may undergo chemical reactions, e.g., hydrolysis, oxidation, and polymerization.

These chemical reactions and flavor infusions may shorten the useful life of the cooking medium, and may result in more frequent replacement of cooking medium. As many operators of fryer apparatus transition to using more expensive cooking media, i.e., zero trans fat cooking media, replacement of an entire batch of cooking medium may be expensive and time consuming. Thus, known fryer apparatus include filtering mechanisms to remove foreign objects, clumps, and crumbs from the cooking medium, in order to preserve the useful life of the cooking medium. In known fryer apparatus, a paper-type filter is used to filter the cooking medium. This paper-type filter may be fitted over a metal filter grating, in order to prevent the paper-type filter from being drawn down a drainage drain when the cooking medium is drawn out by the filtering system. The paper-type filters have a limited life span and must be changed at periodic intervals. In known fryer apparatus, this process may be difficult, time-consuming, and messy. For this and for other reasons, the operation of changing the filter may result in significant down time, i.e., time out of service, for the fryer apparatus, which is not desirable, particularly in operations in which the fryer apparatus is expected to process a high volume of food products.

In addition, because of the design of known cooking apparatus, the filter may sit awkwardly or unlevel with the filter drain pan. This may allow buildup of undesirable foreign materials, e.g., crumbs, clumps of cooking debris, or cracklings, which remain in the filter system, reducing the speed and effective life of the filter, as well as shortening the effective usable life of the cooking medium.

Further, the filter element may be secured to a wall of the filter pan near either the intake or the outlet valve, so that the cooking medium is guaranteed to pass through the filter element. In known fryer apparatus, this may be accomplished only through the use of moving parts, which often require tools to release or adjust. This adds to the complexity of changing the filter element, may increase the chances of contamination of the cooking medium, and may result in less efficient filtering as foreign objects cluster around the moving parts of the filter element securing portions.

### SUMMARY OF THE INVENTION

Therefore, a need has arisen for systems and methods for a cooking apparatus that overcome these and other shortcomings of the related art. Specifically, the invention relates to the use of a filter screen, and a filter pan particularly designed to engage with the filter screen. A technical advantage of the invention is that the filter pan simplifies the filter replacement process, reducing down time of fryer apparatus, and increasing fryer apparatus efficiency. Another technical advantage of the invention is the increased number of filtrations that may occur before replacement is necessary. Still another technical advantage of the invention is the ability to accommodate current sizes of disposable filters within the same type of filter system, without the need for customization.

In an embodiment of the invention, a filter pan for holding and filtering cooking medium comprises an outlet passage, formed through a bottom portion of the filter pan, configured to allow cooking media to be discharged; a groove formed in the bottom portion of the filter pan and surrounding the outlet passage; and a two-sided filter screen, configured to be removable, comprising an adaptor configured to couple the filter screen to the bottom portion of the filter pan at the outlet passage. The adaptor comprises an engaging portion protruding from the filter screen and configured to fit at least partially into the outlet passage; and a raised segment surrounding a base portion of the engaging portion and configured to fit at least partially in the groove, such that the filter screen does not contact the bottom portion of the filter pan; wherein the engaging portion comprises a connector configured to create a seal between the adaptor and the outlet passage.

In another embodiment of the invention, a fryer apparatus comprises a cooking chamber configured to hold cooking media therein and to cook food products therein, and a filter pan. The filter pan comprises an outlet passage, formed through a bottom portion of the filter pan, configured to allow cooking media to be discharged; a groove formed in the bottom portion of the filter pan and surrounding the outlet passage; and a two-sided filter screen, configured to be removable, comprising an adaptor configured to couple the filter screen to the bottom portion of the filter pan at the outlet passage. The adaptor comprises an engaging portion protruding from the filter screen and configured to fit at least partially into the outlet passage; and a raised segment surrounding a base portion of the engaging portion and configured to fit at least partially in the groove, such that the filter screen does not contact the bottom portion of the filter pan; wherein the engaging portion comprises a connector configured to create a seal between the adaptor and the outlet passage. The fryer apparatus further comprises a tube extending from the outlet passage of the filter pan to an inlet of the frying chamber, wherein the tube is configured to be coupled to the inlet of the frying chamber. The filter pan is configured to be removed from the fryer apparatus by pulling on a filter pan handle, the filter screen apparatus is configured to be removed from the filter pan by pulling on the filter screen, and the filter element is configured to be removed by pulling the element from the filter screen, e.g., after the filter screen apparatus has been separated from the filter pan.

Other objects, features, and advantages of the present invention are apparent to persons of ordinary skill in the art in view of the following detailed description of the invention and the accompanying drawings.

### BRIEF DESCRIPTION OF THE DRAWINGS

For a more complete understanding of the embodiments of the present invention, needs satisfied thereby, and the objects, features, and advantages thereof, reference now is made to the following description taken in connection with the accompanying drawings.

FIG. 1 is a front view of a fryer apparatus, according to an embodiment of the invention.

FIG. 2 is a plan view of a fryer pan with a filter screen, according to an embodiment of the invention.

FIG. 3 is a top view of an outlet passage formed in a filter pan, according to an embodiment of the invention.

FIG. 4 is a plan view of a filter screen including an adaptor, according to an embodiment of the invention.

FIG. 5 is a side view of a filter screen with a filter envelope coupled to an outlet passage of a filter pan, according to an embodiment of the invention.

FIG. 6 is a plan view of a fryer pan with a filter screen, according to an embodiment of the invention.

FIG. 7 is a plan view of a filter weight, according to an embodiment of the invention.

FIG. 8 is a top view of a filter pan with a lid, according to an embodiment of the invention.

FIG. 9 is a cross-sectional view of the filter pan depicted in FIG. 8, taken along line C-C.

FIG. 10 is a side view of a filter pan, according to an embodiment of the invention.

FIG. 11 is a cross-sectional view of the filter pan depicted in FIG. 10, taken along line A-A.

FIG. 12 is a cross-sectional view of the filter pan depicted in FIG. 10, taken along line B-B.

FIG. 13 is a plan view of a filter pan, according to an embodiment of the invention.

FIG. 14 is a plan view of a filter pan, according to an embodiment of the invention.

### DETAILED DESCRIPTION OF EMBODIMENTS OF THE INVENTION

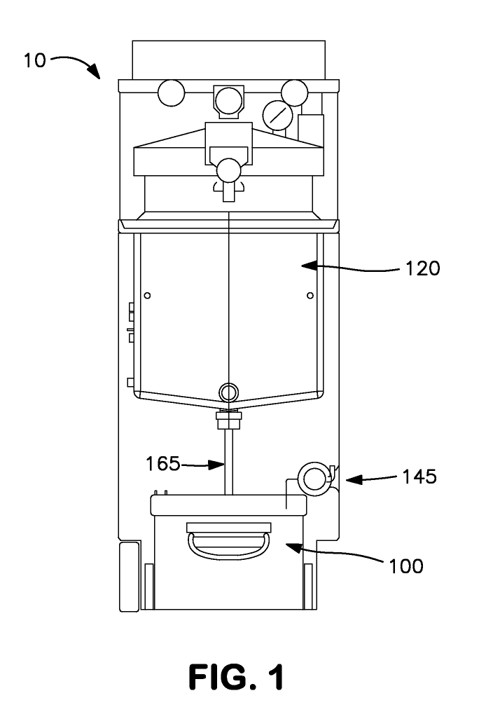

Preferred embodiments of the present invention, and their features and advantages, may be understood by referring to FIGS. 1-14, like numerals being used for corresponding parts in the various drawings.

FIG. 1 depicts a flyer apparatus 10, e.g., a pressure fryer or an open fryer, according to an embodiment of the invention. Fryer apparatus 10 may comprise at least one cooking chamber 120, which may be configured to hold a cooking medium, e.g., an oil, a liquid shortening, a meltable-solid shortening, a semi-solid shortening, or the like. Fryer apparatus 10 also may comprise a filter pan 100 configured to hold and filter cooking media. Further, fryer apparatus 10 may comprise a connecting tube 165 that creates a pathway for cooking media to be drained from cooking chamber 120 to filter pan 100 to be filtered. Fryer apparatus 10 may include an opening whereby filter pan 100 may be inserted into and removed from a cavity below cooking chamber 120. In addition, fryer apparatus 10 may comprise a return pump 145. When activated, return pump 145 may facilitate movement of the cooking medium through a filter element in filter pan 100, and return filtered cooking medium to cooking chamber 120.

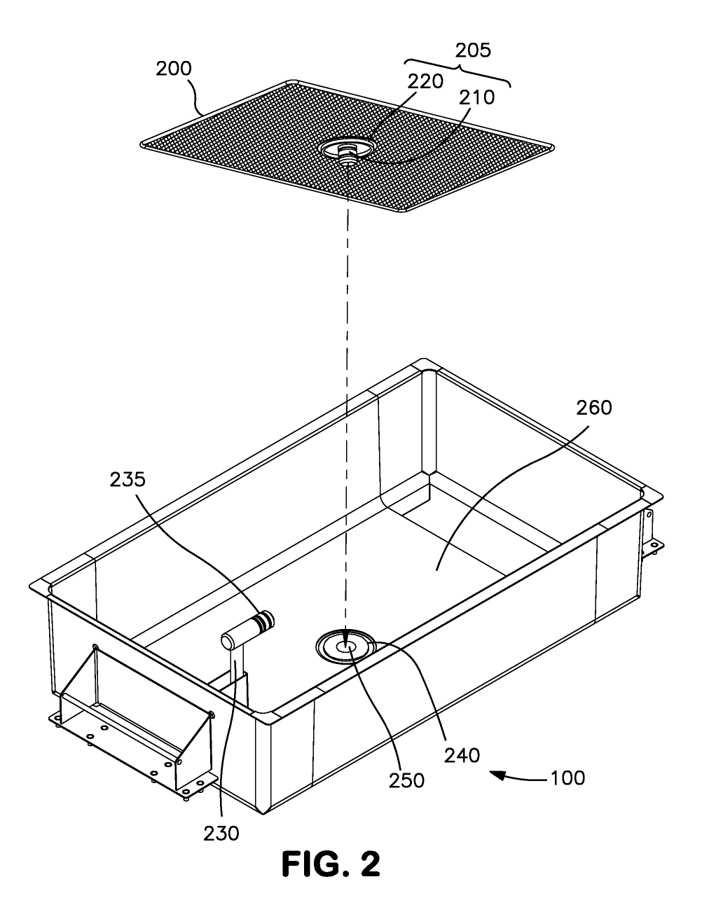

FIG. 2 depicts filter pan 100 with a filter screen 200 separated from the body of filter pan 100. Although the cross section of filter pan 100 is depicted as being substantially rectangular, the cross section of filter pan 100 may be an alternative closed-curve or polygonal shape, e.g., square, circular, elliptical, or triangular. Filter screen 200 may comprise two or more metal mesh surfaces which define a filter cavity therebetween. Alternatively, a single sheet of mesh may be folded upon itself and sealed at three edges to define the filter cavity, or filter screen 200 may comprise a single mesh surface. Filter screen 200 may have at least one handle (not depicted) or a handle may be omitted. Although filter screen 200 is depicted as rectangular in FIG. 2, filter screen 200 may be an alternative closed-curve or polygonal shape, e.g., square, circular, elliptical, or triangular, or may have a three-dimensional design, e.g., sphere, cylinder, cube, or cone. An outlet passage 250 may be formed through a bottom portion 260 of filter pan 100. Although bottom portion 260 of filter pan 100 is depicted as being substantially flat, bottom portion 260 may have an alternative design, e.g., a convex portion, a concave portion, ridges, or indentations, to alter the flow of cooking media during filtration.

Outlet passage 250 may be configured to allow filtered cooking media to be drawn from filter pan 100 and to be returned to cooking chamber 120 via a return tube 230. Return tube 230 may have a connector 235 configured to couple return tube 230 to an inlet of return pump 145. Connector 235 may be configured to removably seal return tube 230 to an inlet of return pump 145 for returning filtered cooking media to cooking chamber 120. Connector 235 may be configured to allow for removal of filter pan 100 from fryer apparatus 10 without the use of tools or physical contact with the connection. In an embodiment, connector 235 may comprise three o-rings to seal return tube 230 to the inlet. In other embodiments, connector 235 may comprise fewer or greater than three o-rings, or there may be an alternative connector mechanism, e.g., a threaded attachment, a sealant, a dairy union connector, a gasket, or the like.

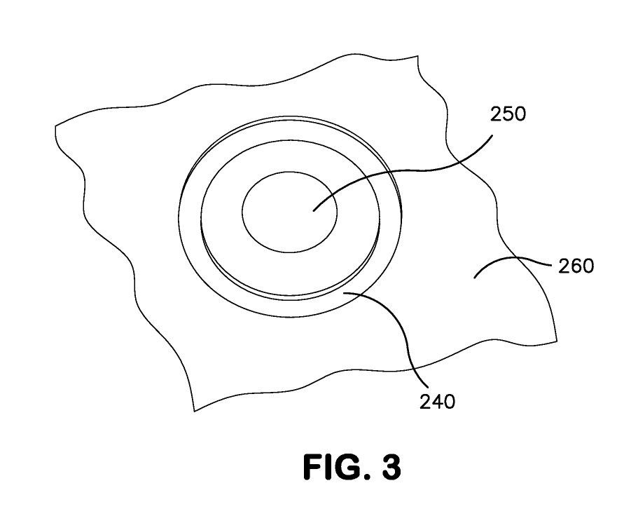

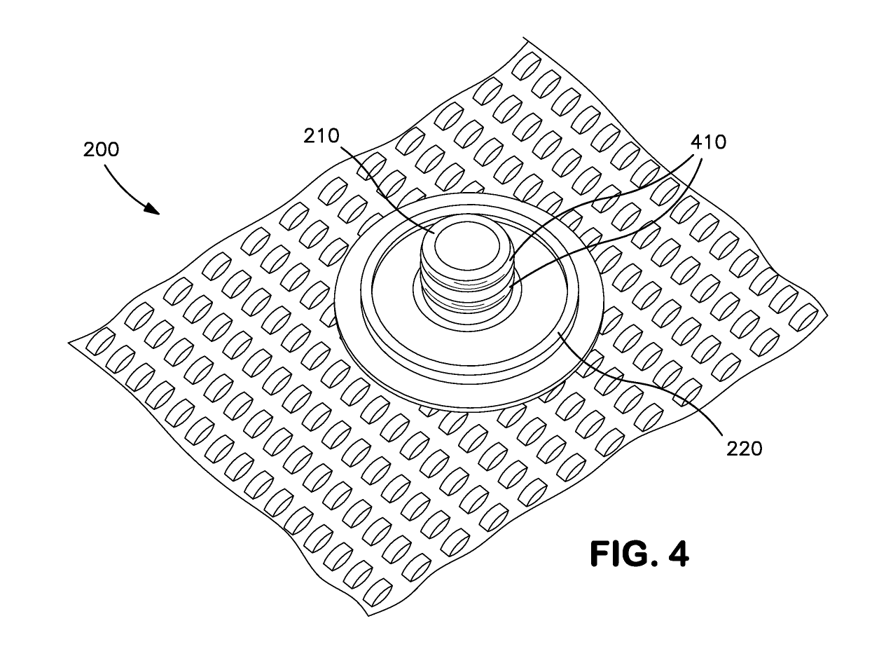

A groove 240 may be formed in bottom portion 260 of filter pan 100. As depicted in FIG. 3, groove 240 may be formed to surround outlet passage 250 with a predetermined distance between groove 240 and an edge of outlet passage 250. In an embodiment, groove 240 is in the shape of a ring, as depicted in FIG. 3. Nevertheless, in other embodiments, groove 240 may be formed in different closed-curve or polygonal shapes, e.g., rectangular, square, elliptical, or triangular. With reference to FIGS. 2 and 4, filter screen 200 may include an adaptor 205 configured to couple filter screen 200 to bottom portion 260 of filter pan 100 at outlet passage 250. Adaptor 205 may comprise an engaging portion 210 that protrudes from one surface of filter screen 200. Engaging portion 210 may be configured to fit at least partially into outlet passage 250, and outlet passage 250 may be configured to receive engaging portion 210. Further, engaging portion 210 may comprise a connector configured to create a seal between adaptor 205 and outlet passage 250. In an embodiment, the connector of engaging portion 210 may comprise two o-rings 410, as depicted in FIG. 4. In other embodiments, the connector of engaging portion 210 may comprise greater or fewer than two o-rings, or there may be an alternative connector mechanism, e.g., a threaded attachment, a sealant, a dairy union connector, a gasket, or the like.

Adaptor 205 also may comprise a raised segment 220. Raised segment 220 may surround a base portion of engaging portion 210. Further, raised segment 220 may be configured to fit at least partially in groove 240. Thus, in an embodiment, raised segment 220 may be in the shape of a ring, as depicted in FIG. 4. Nevertheless, in other embodiments, raised segment 220 may be formed in different closed-curve or polygonal shapes, e.g., rectangular, square, elliptical, or triangular. In an embodiment, groove 240 may have a slightly larger width and a slightly shallower depth than that of raised segment 220. This relationship between groove 240 and raised segment 220 may allow filter screen 200 to be disposed at a predetermined height above the bottom of filter pan 100, such that the flow of cooking media is improved on and through the underside of filter screen 200.

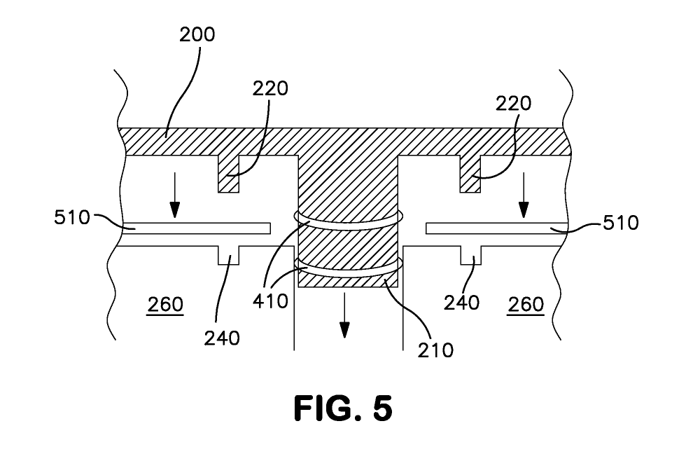

In FIG. 5, filter screen 200 is coupled to bottom portion 260 of filter pan 100. Filter screen 200 and filter pan 100 may be configured such that filter screen 200 may be engaged and disengaged with filter pan 100 without the use of tools or physical contact with the connection. Filter screen 200 may be configured to receive a filter element 510, e.g., a two-sided filter envelope or other filter media. The filter comprises the combination of filter screen 200 and filter element 510. Filter element 510 may have an opening through which engaging portion 210 may protrude. In an embodiment, the opening in filter element 510 may have a diameter that is less than the diameter of each of raised segment 220 and groove 240. In other embodiments, the opening in filter element 510 may have a cross-sectional area that is less than the cross-sectional area of each of the shapes defined by raised segment 220 and groove 240. Engaging portion 210 may fit at least partially into outlet passage 250, with o-rings 410 creating a seal between engaging portion 210 and outlet passage 250. Raised segment 220 may fit at least partially in groove 240. Filter element 510 may be pinched between raised segment 220 and groove 240 when filter screen 200 is coupled to bottom portion 260 of filter pan 100, as depicted in FIG. 5. Thus, groove 240 may aid in sealing filter element 510 between filter screen 200 and filter pan 100 to prevent undesirable foreign materials, e.g., crumbs, clumps, or cracklings, from bypassing the filter during filtration.

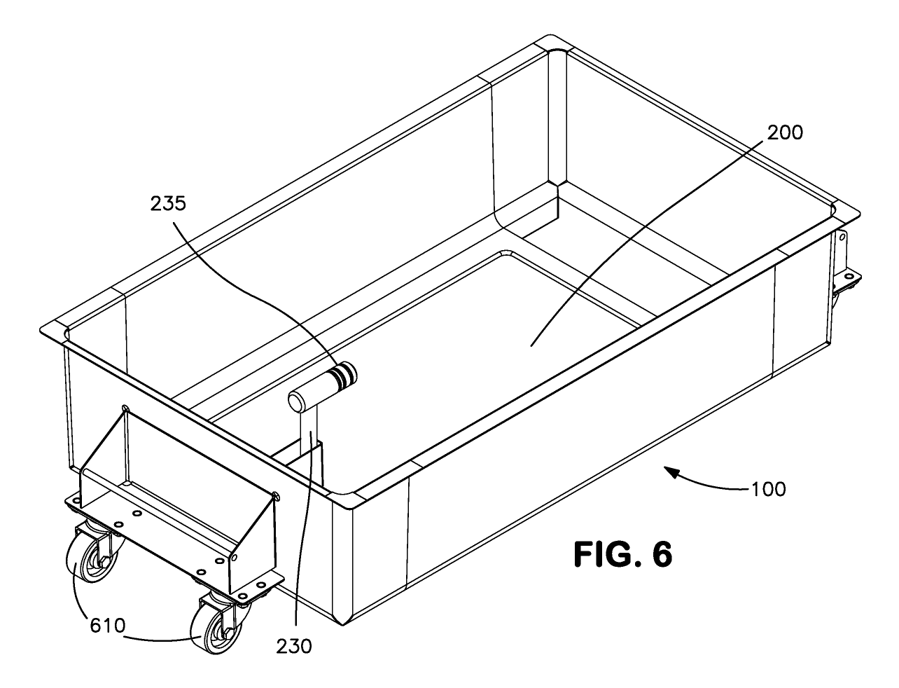

FIG. 6 depicts filter pan 100 with filter screen 200 coupled to bottom portion 260 of filter pan 100, according to an embodiment. Filter pan 100 may have a transporting mechanism 610 to assist in moving filter pan 100. In an embodiment, transporting mechanism 610 may be casters, as depicted in FIG. 6. In other embodiments, transporting mechanism 610 may be a different transporting device, e.g., wheels without caster, sliders, ball casters, rollers, or the like.

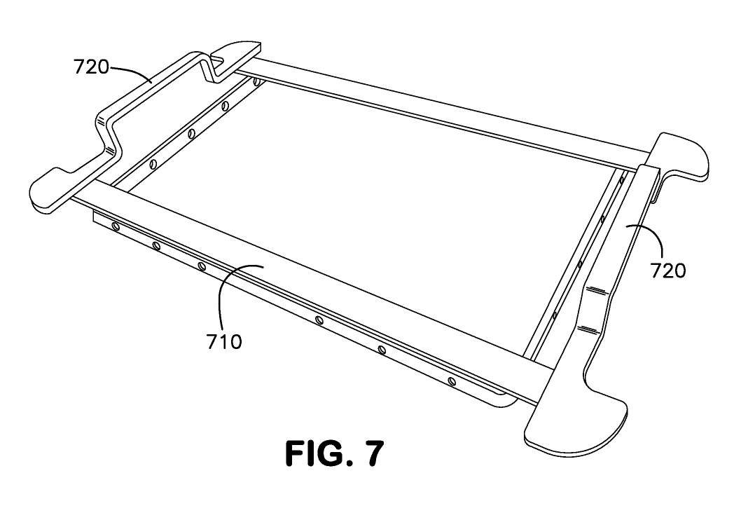

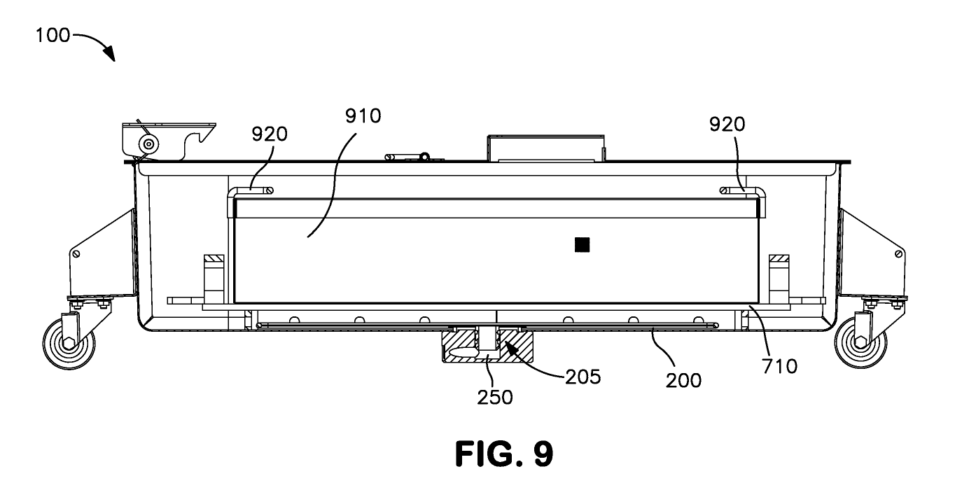

FIG. 7 depicts a filter weight 710, according to an embodiment. Filter weight 710 may have at least one filter weight handle 720. In other embodiments, filter weight handle 720 may be omitted from filter weight 710. Filter pan weight 710 may be configured to rest on top of filter screen 200 and may prevent billowing of filter element 510 or may hold down filter element 510 towards bottom surface 260 of filter pan 100, or both. Thus, if a user does not fold an open end of filter element 510, filter element 510 still may be sealed to prevent undesirable foreign materials, e.g., crumbs, clumps, or cracklings, from bypassing the filter during filtration. In addition, filter weight 710 may provide spacing between a foreign material basket 910 (depicted in FIG. 9) and filter screen 200, which may contribute to increasing the useful life of the filter. Although filter weight 710 is depicted in FIG. 7 as being substantially rectangular, filter weight 710 may be formed in an alternative closed-curve or polygonal shape, e.g., square, circular, elliptical, or triangular.

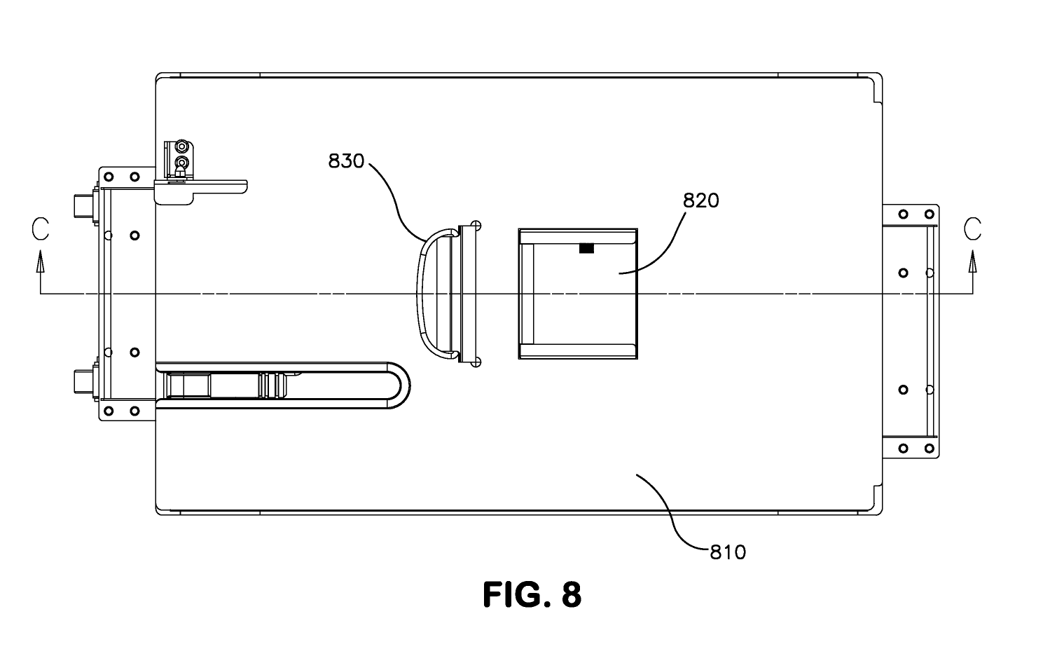

Filter pan 100 may include a lid 810, as depicted in FIG. 8. Lid 810 may be configured to minimize splashing of cooking media as the cooking media is drained from cooking chamber 120 to filter pan 100. Although lid 810 is depicted as substantially flat and rectangular in FIG. 8, lid 810 may be an alternative closed-curve or polygonal shape, e.g., square, circular, elliptical, or triangular, or may have a convex or concave design. An inlet passage 820 may be formed in lid 810. In an embodiment, the cross section of inlet passage 820 may have a square shape, as depicted in FIG. 8. In other embodiments the cross section of inlet passage 820 may have an alternative closed-curve or polygonal shape, e.g., rectangular, circular, elliptical, or triangular. The cooking media may drain from cooking chamber 120 through inlet passage 820 to enter filter pan 200. In an embodiment, cooking media may flow through connecting tube 165 (depicted in FIG. 1) from cooking chamber 120 to filter pan 100 via inlet passage 820. Lid 810 may be configured to be removable from filter pan 100 to allow for servicing of the filter, e.g., replacing filter element 510, cleaning filter screen 200, cleaning or removing basket 910, or cleaning filter pan 100. Lid 810 may include a handle 830 to assist in removing lid 810 from filter pan 100.

FIG. 9 is a cross-sectional view of filter pan 100, as depicted in FIG. 8, taken along line C-C. Filter screen 200 may be coupled to bottom portion 260 of filter pan 100 at outlet passage 250. Engaging portion 210 may at least partially fit into outlet passage 250, and raised segment 220 may at least partially fit in groove 240. Filter weight 710 may be disposed above filter screen 200 and basket 910 may be disposed above filter weight 710, such that filter weight 710 may provide spacing between filter screen 200 and basket 910. Basket 910 may be configured to be removable and may separate crumb particles from the cooking media being filtered, which may increase the useful life of the filter. In an embodiment, basket 910 may comprise perforated sheet metal, bent in the shape of a five-sided box with an open end facing upward. In other embodiments, basket 910 may have greater or fewer than five sides and may be formed in alternative shapes. In an embodiment, basket 910 is formed with a woven-wire mesh having openings of about 0.033 inches (0.084 cm) in diameter. Basket 910 may have a plurality of handles affixed thereto. For example, basket 910 may have two handles welded to the front and rear sides of basket 910 to allow a user to remove basket 910 for crumb removal and cleaning. In other embodiments, basket 910 may have fewer or greater than two handles, or the handles may be omitted, and handles may be attached by alternative means, e.g., screws, clasps, clips, adhesive, or the like.

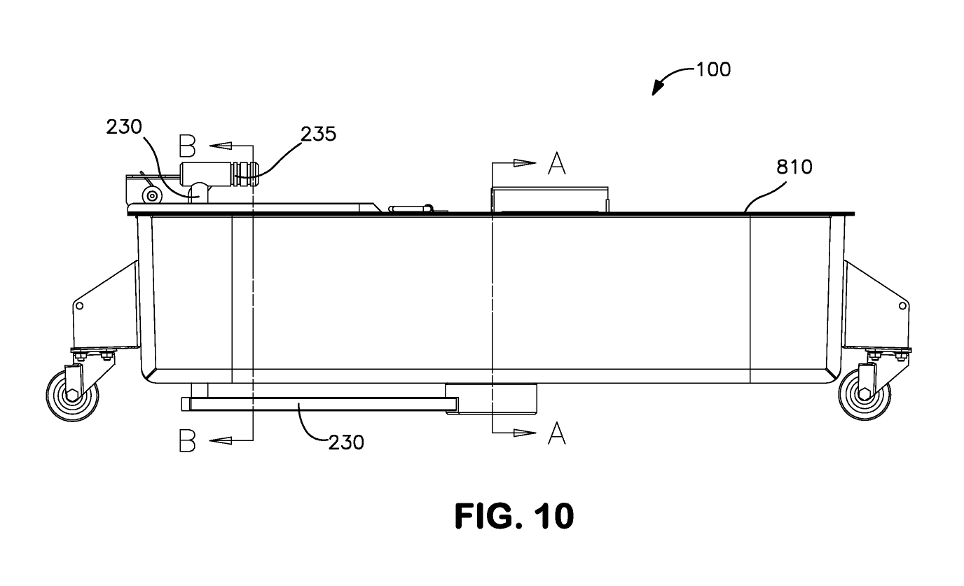

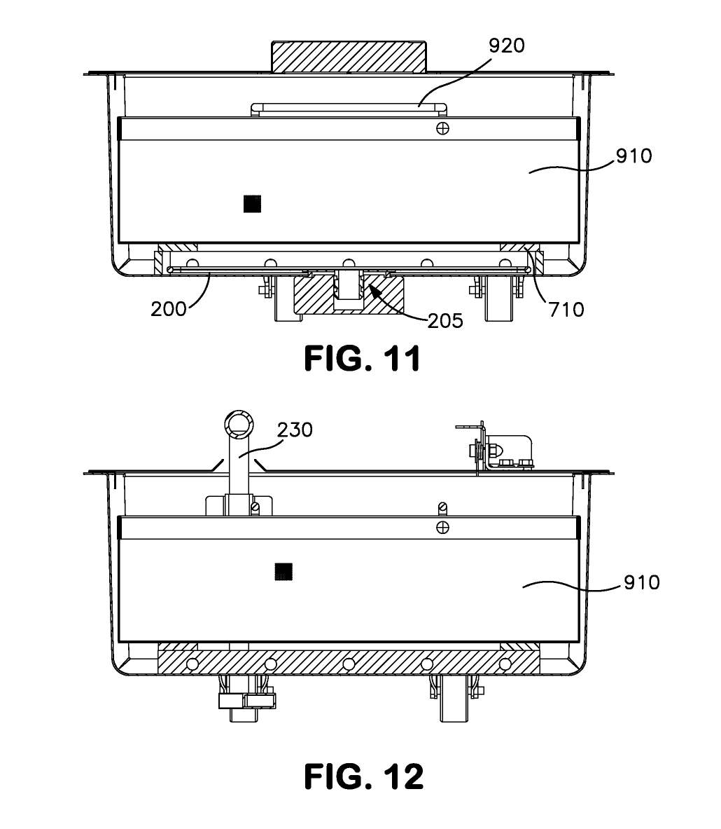

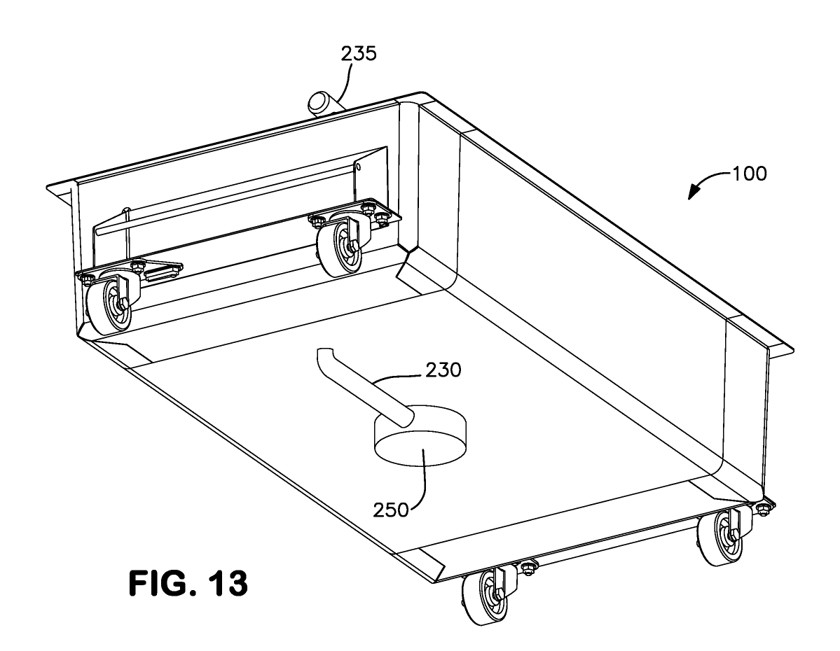

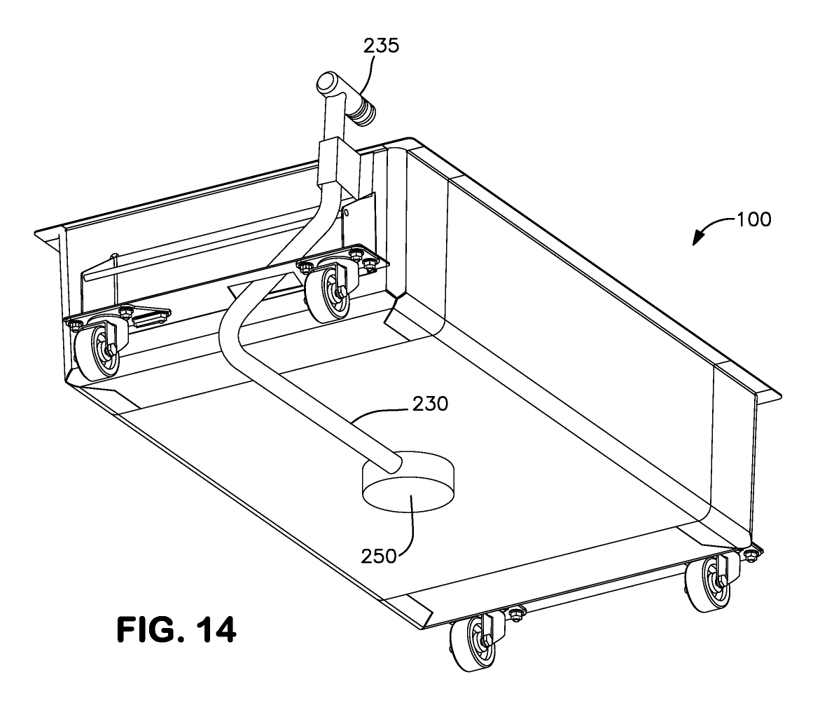

As depicted in FIG. 10, return tube 230 may extend from outlet passage 250, beneath filter pan 100, and back up through filter pan 100 and lid 810 to connector 235. FIG. 11 is a cross-sectional view of filter pan 100, as depicted in FIG. 10, taken along line A-A. FIG. 12 is a cross-sectional view of filter pan 100, as depicted in FIG. 10, taken along line B-B. FIG. 11 depicts basket 910, including handle 920, disposed above filter weight 710. Further, filter screen 200 is disposed below filter weight 710, such that there is a predetermined distance between basket 910 and filter screen 200. In other embodiments, filter weight 710 may be omitted. FIG. 12 depicts return tube 230 extending up through filter pan 100, and further through an opening in lid 810. As depicted in FIG. 13, return tube 230 may extend from outlet passage 250, underneath filter pan 100, on an angle, such that return tube 230 extends upward through the interior of filter pan 100 and closer to one side (e.g., a front side aligned with the opening in fryer apparatus 10, when filter pan 100 is inserted beneath cooking chamber 120) of filter pan 100 than an opposing side (e.g., a rear side). In another embodiment, return tube 230 may extend completely along the exterior of filter pan 100, as depicted in FIG. 14, rather than extending up through filter pan 100, as depicted in FIG. 13. With reference to FIG. 14, filter pan 100 may comprise a bracket on the outside of filter pan 100 to secure, or provide support for, return tube 230.

To service a filter apparatus, according to an embodiment, a user may first pull filter pan 100 out from the underneath flyer apparatus 10, a process that may require no tools or additional operations to disengage return tube 230 from the inlet of return pump 145. With filter pan 100 withdrawn from underneath fryer apparatus 10, a user may then remove lid 810 to access basket 910, filter weight 710, and filter screen 200. The basket 910 may be removed and foreign material within the basket may be quickly discarded. Filter weight 710 then may be removed to access filter screen 200. To remove filter element 510 from filter pan 100, a user may first lift filter screen 200 and filter element 510 out of filter pan 100. With filter screen 200 and filter element 510 holding the foreign material, a user may transport the filter and foreign material to a disposal location. The user may pull filter element 510 from filter screen 200 and may dispose of filter element 510. Most of the foreign material may be contained by basket 910 and filter element 510, and the removal of the foreign material from filter pan 100 would be achieved substantially during the servicing of these two items. Any foreign material still remaining within filter pan 100 may be quickly removed for disposal. With filter pan 100 clean of foreign material, a user then may place a clean filter element 510 around filter screen 200 and connect filter screen 200 with filter element 510 into outlet passage 250 at bottom portion 260 of filter pan 100 by inserting engaging portion 210 of adaptor 205 into outlet passage 250 and pressing down on the top side of filter screen 200. Filter weight 710, basket 910, and lid 810 may then be put back on and filter pan 100 may be slid back underneath cooking chamber 120 in fryer apparatus 10, which re-establishes the connection between return tube 230 of filter pan 100 and the inlet of return pump 145. Because filter pan 100 with the removable two-sided filter screen 200 does not require tools to undo the connection points and because the process for disposal and replacement of filter element 510 may be quicker and less complicated, the user may spend less time servicing the filter and filter pan 100 than with known filter pan designs. This reduces the amount of downtime associated with the filter replacement process, allowing the user to spend more time with other activities associated with food preparation.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. The specification and the described examples are considered as exemplary only, with the true scope and spirit of the invention indicated by the following claims.

What is claimed is:

1. A filter pan for holding and filtering cooking media, the filter pan comprising:
an outlet passage, formed through a bottom portion of the filter pan, configured to allow cooking media to be discharged;
a groove formed in the bottom portion of the filter pan and surrounding the outlet passage;
a two-sided filter screen, configured to be removable, comprising an adaptor configured to couple the filter screen to the bottom portion of the filter pan at the outlet passage,
wherein the adaptor comprises:
an engaging portion protruding from the filter screen and configured to fit at least partially into the outlet passage; and
a raised segment surrounding a base portion of the engaging portion and configured to fit at least partially in the groove, such that the filter screen does not contact the bottom portion of the filter pan;
wherein the engaging portion comprises a connector configured to create a seal between the adaptor and the outlet passage.

2. The filter pan of claim 1, wherein the filter screen is configured to receive a filter envelope.

3. The filter pan of claim 2, wherein the engaging portion protrudes through an opening formed in the filter envelope and a portion of the filter envelope is disposed between the groove and the raised segment when the filter screen is coupled to the bottom portion of the filter pan.

4. The filter pan of claim 1, further comprising:
an inlet passage configured to allow cooking media to enter the filter pan.

5. The filter pan of claim 4, further comprising:
a lid configured to cover the filter pan, wherein the inlet passage is formed in the lid.

6. The filter pan of claim 1, further comprising:
a tube extending from the outlet passage to a return pump inlet, wherein the tube is configured to be coupled to the return pump inlet.

7. The filter pan of claim 6, wherein the tube comprises a connector configured to removably seal the tube to the return pump inlet for returning filtered cooking medium to a fryer apparatus.

8. The filter pan of claim 1, further comprising:
a foreign material basket, configured to be removable, disposed between the filter screen and the lid.

9. The filter pan of claim 8, wherein the basket comprises:
a mesh grid supported by a frame; and
a handle for removing the basket from the filter pan.

10. The filter pan of claim 8, further comprising:
a filter weight configured to sit atop the filter screen and provide spacing between the filter screen and the basket.

11. The filter pan of claim 10, wherein the basket is configured to sit atop the filter weight.

12. A fryer apparatus, comprising:
a cooking chamber configured to hold cooking media therein and to cook food products therein;
a filter pan, the filter pan comprising:
an outlet passage, formed through a bottom portion of the filter pan, configured to allow cooking media to be discharged;
a groove formed in the bottom portion of the filter pan and surrounding the outlet passage;
a two-sided filter screen, configured to be removable, comprising an adaptor configured to couple the filter screen to the bottom portion of the filter pan at the outlet passage,
wherein the adaptor comprises:
an engaging portion protruding from the filter screen and configured to fit at least partially into the opening; and
a raised segment surrounding a base portion of the engaging portion and configured to fit at least partially in the groove, such that the filter screen does not contact the bottom portion of the filter pan;
wherein the engaging portion comprises an o-ring connector configured to create a seal between the adaptor and the outlet passage; and
a tube extending from the outlet passage to an inlet of the frying chamber, wherein the tube is configured to be coupled to the inlet of the frying chamber.

13. The fryer apparatus of claim 12, wherein the filter screen is configured to receive a filter envelope.

14. The fryer apparatus of claim 13, wherein the engaging portion protrudes through an opening formed in the filter envelope and a portion of the filter envelope is disposed between the groove and the raised segment when the filter screen is coupled to the bottom portion of the filter pan.

15. The filter pan of claim 12, further comprising:
an inlet passage configured to allow cooking media to enter the filter pan.

16. The filter pan of claim 15, further comprising:
a lid configured to cover the filter pan, wherein the inlet passage is formed in the lid.

17. The filter pan of claim 12, wherein the tube comprises a connector configured to removably seal the tube to the inlet of the frying chamber for returning filtered cooking medium via a pump.

18. The filter pan of claim 1, further comprising:
a foreign material basket, configured to be removable, disposed between the filter screen and the lid.

19. The filter pan of claim 18, wherein the basket comprises:
a mesh grid supported by a frame; and
a handle for removing the basket from the filter pan.

20. The filter pan of claim 8, further comprising:
a filter weight configured to sit atop the filter screen and provide spacing between the filter screen and the basket;
wherein the basket is configured to sit atop the filter weight.
